(19) United States
(12) Patent Application Publication
(10) Pub. No.: US 2004/0056638 A1
(43) Pub. Date: Mar. 25, 2004

(54) Electrical outlet and back-up power supply for the same

(76) Inventors: Claire E. Bamber, Cincinnati, OH (US); Jeffrey V. Bamber, Cincinnati, OH (US)

Correspondence Address: Jeffrey V. Bamber, 5023 Village Drive, Cincinnati, OH, 45244, US

(21) Appl. No.: 10/664,439

(22) Filed: Sep. 19, 2003

Related U.S. Application Data
(60) Provisional application No. 60/412,401, filed on Sep. 20, 2002.

(51) Int. Cl. H02J 7/00

(52) U.S. Cl. 320/112

(57) ABSTRACT

An electrical outlet having a back-up power supply is disclosed. In one embodiment, the electrical outlet includes an outlet box that is housed in a recess behind a wall, and the back-up power supply is located in the same recess.

### CROSS-REFERENCE TO RELATED APPLICATIONS

This application claims the benefit of the filing date of U.S. Provisional Patent application Serial No. 60/412,401, filed on Sep. 20, 2002, which is incorporated by reference herein.

### FIELD OF THE INVENTION

The present invention relates to an electrical outlet, and more particularly to an electrical outlet having a back-up power supply.

### BACKGROUND OF THE INVENTION

It is not uncommon for the electrical power supply in buildings, houses, etc. to occasionally be interrupted, such as during storms, or in the event of an accident that damages electrical lines or generation stations. This can cause great inconvenience to people occupying these building and houses. It becomes dark and people are often unable to use desktop computers and other types of electrically powered equipment. Currently, when the electrical power supply is interrupted, people will have to wait until the power comes back on to resume their normal activities. The most common way of dealing with darkness is for people to use flashlights, provided they can be found, and are operational. Thus, there is a need to provide an improved means for dealing with the interruption of electrical power to buildings, houses, and other structures or spaces.

U.S. Pat. No. 5,701,244 issued to Emmert, et al. (assigned to Motorola, Inc.) is directed to an uninterruptible power supply (UPS). The uninterruptible power supply disclosed in this reference is contained in a housing that supports the major electrical components of the UPS, including a transformer circuit, a switching circuit, and a battery. A connector affixed to the housing is capable of removably affixing the UPS to an alternating current (AC) outlet.

### SUMMARY OF THE INVENTION

The present invention relates to an electrical outlet, and more particularly to an electrical outlet having a back-up power supply.

There are numerous, non-limiting embodiments of the invention. All embodiments, even if they are only described as being “embodiments” of the invention, are intended to be non-limiting (that is, there may be other embodiments in addition to these), unless they are expressly described as limiting the scope of the invention.

In one non-limiting embodiment, the electrical outlet includes an outlet box that is housed in a recess behind a wall, and the back-up power supply is located in the same recess. In some versions of such an embodiment, the back-up power supply can be located within the electrical outlet box, or it may be joined to the electrical outlet box. The back-up power supply can, therefore, in certain embodiments, be an integral component of the outlet box and/or the outlet.

In other embodiments, the back-up power supply can be located on the outside of the wall. If the back-up power supply is located on the outside of the wall, in some embodiments, it can be plugged into the plug receptacles of an electrical wall outlet. In one version of such an embodiment, the back-up power supply can be provided with a conventional electrical outlet plug receptacle on one or more of the faces thereof. In such an embodiment, the back-up power supply can be plugged into an electrical wall outlet, and the power cord of the appliance can simply be plugged into the outlet plug on one of the faces of the back-up power supply as if it were being plugged into an electrical wall outlet.

The electrical outlet boxes described herein may also comprise inventions in their own right, as may the back-up power supply that is configured for use with the electrical outlet.

### BRIEF DESCRIPTION OF THE DRAWINGS

While the specification concludes with claims particularly pointing out and distinctly claiming the invention, it is believed that the present invention will be better understood from the following description taken in conjunction with the accompanying drawings in which:

FIG. 1 is a front view of one non-limiting embodiment of a wall-mounted electrical outlet having a back-up power supply, shown with a portion of the wall cut away to show the back-up power supply behind the wall.

FIG. 2 is a front view of an electrical outlet box having a back-up power supply located therein.

FIG. 3 is a front view of another embodiment of a back-up power supply unit, in which the unit is located on the outside of an electrical wall outlet.

### DETAILED DESCRIPTION OF THE INVENTION

The present invention relates to an electrical outlet, and more particularly to an electrical outlet having a back-up power supply.

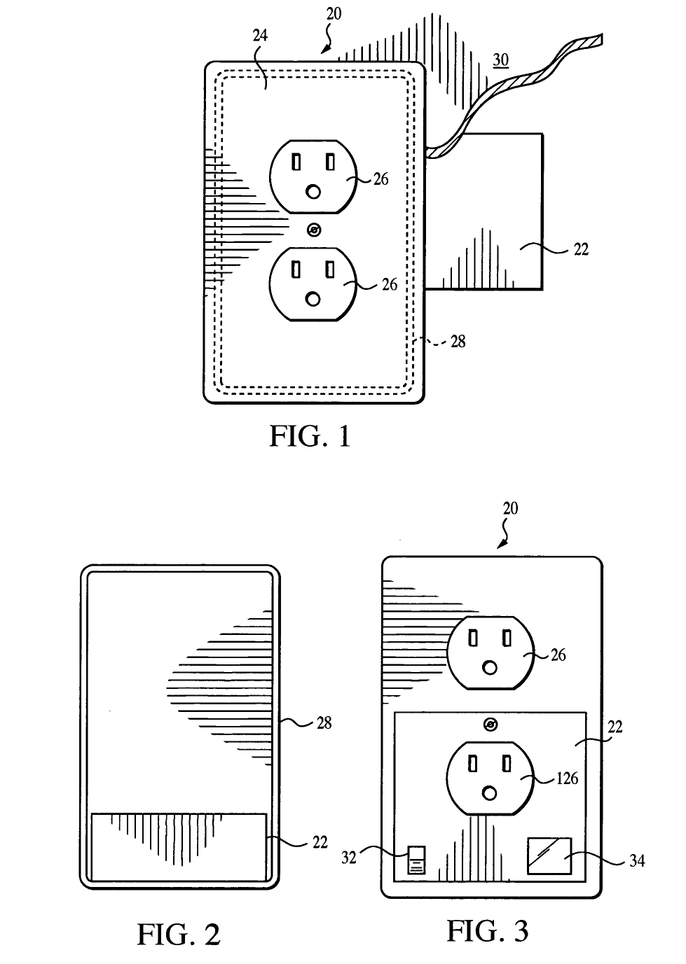

One non-limiting embodiment of an electrical outlet 20 having a back-up power supply 22 is shown in FIG. 1. In the embodiment shown in FIG. 1, the electrical outlet 20 is an alternating current (AC) outlet. The electrical outlet 20 in the embodiment shown comprises an outlet cover 24, and two plug receptacles 26 with electrical contacts therein, and an electrical outlet box 28. In this embodiment, the AC outlet's contacts are jacks having slits for openings. An AC voltage, which can be variable and interruptible, is supplied to the contacts from electric mains. The back-up power supply 22 is preferably adjacent to the electrical outlet 20, although in other embodiments, the back-up power supply 22 can be remote from the electrical outlet 20. The back-up power supply 22 can be provided to power as many electrical outlets as desired, from one outlet (such as to power at least one lamp plugged into the outlet) to all of the electrical outlets within a building, room, or other structure.

The back-up power supply 22 can be housed in the same recess in the wall 30 as the electrical outlet box 28 and can be located out of view behind the wall 30. In other embodiments, the back-up power supply 22 can be located on the same side of the wall 30 as the outlet cover 24 (that is, on the outside of the wall). The back-up power supply 22 may be housed in the outlet box 28, or it may include its own housing. The back-up power supply 22 can provide a back-up source of AC and/or DC power. The back-up power supply 22 can be any type of power supply that can provide power when the current is not flowing to the electrical outlet 20. Suitable back-up power supplies include, but are not limited to generators and batteries. Any suitable type of battery can be used, including disposable batteries, reusable batteries, or both. Suitable disposable batteries include but are not limited to alkaline batteries. Suitable rechargeable batteries include, but are not limited to nickel-cadmium, nickel-metal hydride, lithium ion batteries, and any other suitable batteries that may be developed in the future. The battery in the back-up power supply may be readily accessible and easily removable. In some of the discussion herein, the back-up power supply 22 may be referred to as a battery, but it should be clear that it is not limited to a battery. The back-up power supply 22 can comprise one or more power sources. If there is more than one power source, such power sources may be of the same type, or a combination of different types of power sources.

The electrical outlet 20 can be a conventional electrical outlet, or it can have a unique configuration that is specially adapted to provide a back-up power supply. In one embodiment, for example, as shown in FIG. 2, the outlet box 28 could be configured to house the back-up power supply 22. The back-up power supply 22 can, therefore, be an integral component of the outlet box 28 and/or the outlet 20. In other embodiments, the outlet box 28 could be configured to allow the back up power supply 22 to be attached thereto. Such outlet boxes 28 may also comprise inventions in their own right, as may the back-up power supply 22 that is configured for use with the electrical outlet 20. The electrical outlet 20 can operate on conventional household electrical current, and the backup power supply 22 can be provided as a back-up source of electricity in the event of power failures or other power outages.

The electrical outlet 20 and back-up power supply 22 may comprise any suitable type of circuitry that allows the back-up power supply 22 to supply power to the electrical outlet 20, particularly when the normal source of power to the outlet 20 is interrupted. Suitable circuitry that may either be used, or modified, to interconnect the back-up power supply 22 and the electrical outlet 20, and to activate the back-up power supply 22 in the event the electrical current is interrupted is described in U.S. Pat. No. 4,323,788 issued to Smith, and U.S. Pat. No. 5,701,244 issued to Emmert, et al. It is expressly not admitted, however, that these patents teach or disclose the present invention, nor that all of the components described in those patents are necessary herein. For example, in certain embodiments, there is no need for a power cord from the back-up power supply 22 to an electrical appliance. Instead, the power cord of the appliance can simply be plugged into the electrical outlet 20 in the usual manner. Alternatively, as shown in FIG. 3, a device such as the UPS described in the Emmert, et al. patent can be modified to serve as the back-up power supply 22 and can be provided with a conventional electrical outlet plug receptacle 126 on one or more of the faces thereof. In such an embodiment, the power cord of the appliance can simply be plugged into the outlet plug 126 on one of the faces of the back-up power supply 22 as if it were being plugged into an electrical wall outlet.

In addition to containing a power source such as a battery, the unit comprising the back-up power supply 22 may also comprise other components such as a transformer circuit and a switching circuit. Alternatively, one or more of these components can be located in or on the outlet box 28, and one or more of these components may be located in a separate housing. The transformer circuit may convert AC power to a main source of DC power and may be electrically coupled with the electrical contacts of the electrical outlet. The term “electrically coupled” includes any type of electrical connection that allows electricity to flow between the components that are electrically coupled. Components can be electrically coupled in any suitable manner including, but not limited to by one or more lines, connecting wires, or electrical connectors. The transformer circuit can be any suitable type of device including, but not limited to a half-wave rectifier circuit.

The switching circuit is electrically coupled between the transformer circuit and the back-up power supply 22, and provides a low-impedance path between the battery and the transformer circuit when the AC voltage is interrupted. When the AC voltage is not interrupted, the switching circuit provides a high-impedance path between the back-up power supply 22 and the transformer circuit.

The electrical outlet 20 with the back-up power supply 22 can power an article, such as a lamp, that is plugged directly into one of the plug receptacles 26, even when there is a power failure, eliminating the problem of occupants having to wait until the power comes back on to resume their normal activities, or using flashlights until the electric current becomes available. In other embodiments, the electrical outlet 20 can supply power to a computer, a refrigerator, or some other type of appliance.

Numerous other embodiments and/or features are possible. For example, in other embodiments, the electrical outlet 20 can operate solely on the back-up power supply 22, without a source of AC current being supplied to the electrical outlet 20.

The outlet 20 and/or back-up power supply 22 can have a switch 32 to turn off the battery in the back-up power supply 22 to save the battery when not in use. In some embodiments, the back-up power supply 22 can be electrically connected to the circuit supplying that electrical current so that it can detect the absence of electrical current, and automatically turn on when there is a power outage. In other embodiments, the back-up power supply 22 can turn on a light 34 so the user can see the outlet well enough to flip a switch 32 to turn on the power source in the back-up power supply 22 in the event of a power failure.

In other embodiments, such as the embodiment shown in FIG. 3, the back-up power supply 22 can plug into one of the plug receptacles 26, and the portion of the circuit connected to the back-up power supply 22 can be arranged so that the power source in the back-up power supply 22, such as the battery, will provide power to a lamp, etc. plugged into the other plug receptacle(s). For example, instead of only supplying power to the electrical outlet plug receptacle 126, the back-up power supply 22 in FIG. 3 can also supply power to the plug receptacle 26 on the top of the outlet 20. The battery in embodiments in which the back-up power supply 22 is plugged into an electrical outlet can be replaceable or rechargeable. If the battery is rechargeable, the battery can be recharged by the current running to the outlet 20 when the back-up power supply 22 is plugged into one of the electrical outlet plug receptacles 26.

The disclosure of all patents, patent applications (and any patents which issue thereon, as well as any corresponding published foreign patent applications), and publications mentioned throughout this description, including the Background of the Invention section, are hereby incorporated by reference herein. It is expressly not admitted, however, that any of the documents incorporated by reference herein teach or disclose the present invention.

While particular embodiments of the subject invention have been described, it will be obvious to those skilled in the art that various changes and modifications of the subject invention can be made without departing from the spirit and scope of the invention. In addition, while the present invention has been described in connection with certain specific embodiments thereof, it is to be understood that this is by way of illustration and not by way of limitation and the scope of the invention is defined solely by the appended claims which should be construed as broadly as the prior art will permit.

What is claimed is:

1. An electrical outlet comprising a back-up power supply that is electrically connected to supply current to the electrical outlet.

2. The electrical outlet of claim 1 comprising an outlet box that is housed in a recess behind a wall, wherein said back-up power supply is also located in said recess.

3. The electrical outlet of claim 2 wherein the back-up power supply comprises a battery.

4. An electrical outlet box, said outlet box comprising a housing which is sized and configured to house a back-up power supply.

5. The electrical outlet box of claim 4 further comprising a back-up power supply in said housing.
